(19) United States
(12) Patent Application Publication
(10) Pub. No.: US 2022/0299237 A1
(43) Pub. Date: Sep. 22, 2022

(54) DEHUMIDIFIER APPARATUS

(71) Applicant: Reddo Floor Solutions AB, Stockholm (SE)

(72) Inventor: Johan ÅHSBERG, Mollösund (SE)

(21) Appl. No.: 17/638,354

(22) PCT Filed: Aug. 25, 2020
(86) PCT No.: PCT/SE2020/050814

§ 371 Date: Feb. 25, 2022

(30) Foreign Application Priority Data
Aug. 26, 2019 (SE) 1950974-4

(51) Int. Cl. F24F 13/30; F24F 3/153; F24F 3/14

(52) U.S. Cl. CPC F24F 13/30; F24F 3/153; F24F 3/1423

(57) ABSTRACT

A dehumidifier apparatus comprising a sorption dehumidifier (10) having a process air inlet (12), a dry air outlet (22) and a wet air outlet (16), According to the invention the apparatus comprises a heat exchanger (50) located at said outlets (16, 22) for heating dry air (18) exiting the dry air outlet (22) by wet air exiting the wet air outlet (16); and a heat insulation (60) enclosing the dehumidifier (10) and the heat exchanger (50).

### FIELD OF THE INVENTION

This invention relates to a dehumidifier apparatus capable of dividing and converting a process air flow into a dry air flow and a heated wet air flow and comprising a sorption dehumidifier having a process air inlet, a dry air outlet and a wet air outlet.

### BACKGROUND OF THE INVENTION

A dehumidifier apparatus of this type is known from SE 540952 C2. Such dehumidifiers are commonly used to temporarily dry water damaged areas, such as wet rooms. Similar dehumidifiers are also commonly used to permanently maintain a uniform climate in areas such as laundry rooms, crawl spaces, ice halls etc. A great portion of the heat generated in the dehumidifiers to produce dry air is then often carried away with the wet air that is lead out to the environment.

In these applications there is however a desire to have a relatively high dry outlet air temperature in order to heat the enclosed area and structures therein so as to more easily draw moisture therefrom.

Another known dehumidifier apparatus of this type is provided with a heat pump to obtain a low energy consumption. This apparatus also produces dry air of a low temperature since the heat pump is used to cool the resulting dry air. The heat pump also adds to the cost of the apparatus.

In yet another known dehumidifier, the hot and humid regeneration air is conducted to a condenser where it emits heat and condensate water needs to be collected.

### DISCLOSURE OF THE INVENTION

An object of this invention is to develop a low cost dehumidifier apparatus of the kind identified above that is capable of efficiently produce relatively hot dry air, also without having to deal with condensate water.

In an aspect of the invention a dehumidifier apparatus according to the invention further comprises

a heat exchanger arranged for heating dry air exiting the dry air outlet by wet air exiting the wet air outlet; and

a heat insulation enclosing the dehumidifier and the heat exchanger.

Thereby, an increased amount of the heat is used to heat the dry air exiting the apparatus. The heated dry air will then more efficiently extract moisture from an enclosed area. In other words, for water restoration purposes, an elevated dry air temperature results in shorter drying time, i.e. fewer machines are needed for the same task thus resulting in lower capital costs. Lower energy consumption also contributes to higher profitability for dehumidification companies, which often bear the cost of electricity, as well as improved sustainability due to lower CO₂-emissions related to energy consumption.

The heat exchanger may be configured for being capable of heating the dry air exiting the apparatus without substantial loss in flow therethrough in order to maintain dehumidification capacity. While the heat exchanger then may be of any suitable type, such as a crossflow exchanger, a heat exchanger according to the invention may comprise a pipe heat exchanger including a heat exchanging element dividing and uniting the wet air flow in the flow path of the dry air flow.

To increase the efficiency of the heat exchanger the heat exchanging element may be provided with heat transfer fins.

The heat exchanging element may also comprise streamlined cross section tubing, and also dimpled surfaces. These features may improve flow and heat transfer efficiency.

Heat insulated tubing may be connected to the wet air outlet for carrying the lower temperature wet air to the atmosphere. This heat insulation prevents water to condensate inside and on the tubing.

The heat insulation may comprise a thicker heat and sound insulation layer and a thinner reflecting layer.

The heat exchanger may extend in a rear space of the apparatus.

The heat exchanger may also extend in a bottom space of the apparatus. Thereby also the process air flow in the apparatus will be heated by the heat exchanger, thus making the apparatus more energy efficient.

The bottom space may further be lined by a heat conducting material. This measure may further enhance the efficiency of the heat exchanger, by more efficiently spreading the heat in the apparatus.

Other features and advantages of the invention may be apparent in the following detailed description and the appended claims.

### BRIEF DESCRIPTION OF DRAWINGS

FIG. 1 is a diagrammatic broken away slanting view illustrating principles of a dehumidifier apparatus according to the invention;

FIG. 2 is a diagrammatic lateral section view of an apparatus according to the invention;

FIG. 3 is a front view of a heat exchange element of an apparatus according to the invention;

FIG. 4 is an oblique view of another heat exchange element of an apparatus according to the invention; and

FIG. 5 is diagrammatic lateral section view of an apparatus according to the invention having a modified heat exchanger.

Components having mutually corresponding functions may be designated with same numerals.

### DETAILED DESCRIPTION OF EXEMPLARY EMBODIMENTS

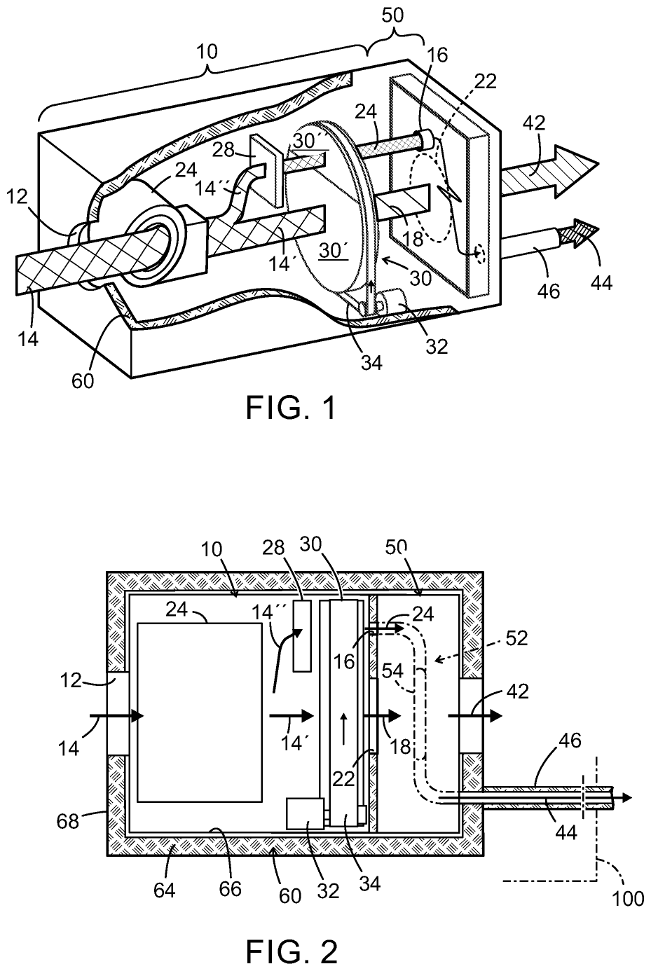

The dehumidifier apparatus according to the invention and shown in FIGS. 1 and 2 generally, and in a manner known per se, comprises a sorption/desiccant dehumidifier 10 having a process air inlet 12, a dry air outlet 22 and a wet air outlet 16.

Dehumidifier 10 further comprises a blower 24, such as a centrifugal blower, or a side channel blower, to push a major portion of process air 14 to a major section 30′ of a desiccant rotor 30. A desiccant, such as silica gel, in the rotor 30 thereby draws moisture from the major portion 14′ of the process air 14 to produce dry air 18. A minor portion 14″ of the process air 14 is guided to a minor recharging section 30″ of the desiccant rotor 30 via a heater 28 such as a PTC heater. The desiccant rotor 30 is rotated by a motor 32 via a belt 34.

The minor portion 14″ of the process air heated before entering the minor section 30″ of the rotor 30 is thereby capable of recharging the desiccant in the rotor by drawing moisture from the desiccant. The minor portion 14″ of the process air 14 is thereby converted to heated wet air 24.

In the embodiments of FIGS. 1 and 2, a gas heat exchanger 50 is arranged to heat the dry air 18 leaving the dehumidifier 10, from a rear space 70 at an outlet end of the apparatus, into heated dry air 42 by the heated wet air 24 also leaving the dehumidifier 10, as cooler wet air 44. The heat exchanger 50 may be of any suitable type such as a crossflow exchanger.

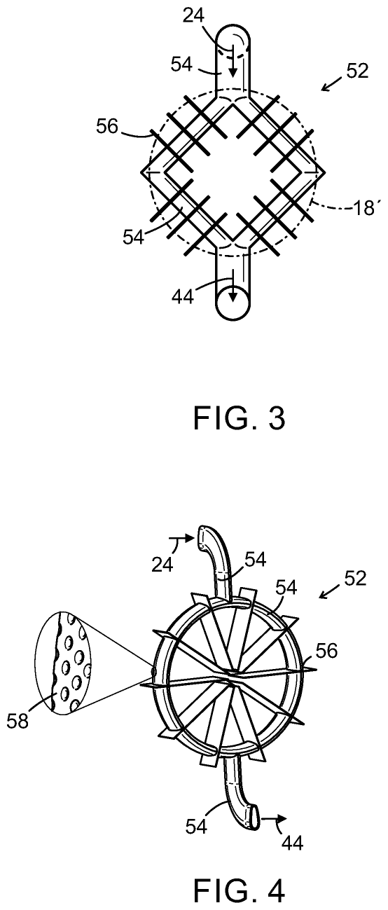

Importantly, the heat exchanger 50 may not too much slow down the flow of dry air 18, and also that of wet air 24, therethrough. In a functioning prototype primary heat exchanger element 52 indicated in phantom in FIG. 2 and shown in more detail in FIG. 3 included a pipe heat exchanger comprising soldered copper pipe sections 54 positioned in the flow path 18′ of dry air 18 and dividing and uniting the wet air outlet flow 24 in succession, e.g. forming encircling parallel wet air flow paths across the dry air flow path 18′.

The exchanger element 52 may also be supplied with fins 56 as to increase the heat transfer from the surfaces of pipe sections 54. FIG. 4 shows an embodiment having a circular heat exchanger element 52 and larger fins 56.

A compromise between heat exchange efficiency and unobstructed dry air flow would be to use tubing having a streamlined cross section for the pipe sections 54 in the dry air flow path as is also shown in FIG. 4. Of course, a plurality of concentric encircling heat exchanger sections 54 may be used (not shown). The heat exchanger sections and fins may possibly also have dimpled, dented, roughened or other uneven exterior (and/or interior) surfaces 58 as depicted in the enlarged area in FIG. 4, for providing a larger surface area and an improved boundary layer flow.

As indicated in FIG. 2, the cooler wet air 44 exiting the heat exchanger 50 is led out to the atmosphere from an enclosure 100 where it is installed via a heat insulated hose/tubing 46.

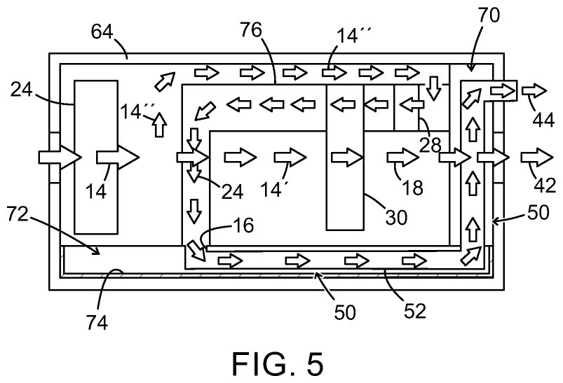

FIG. 5 shows an apparatus having a modified heat exchanger 50. In this embodiment the heat exchanger 50 also extends in a bottom space 72 of the apparatus where the heat exchanger element 52 is connected to the wet air outlet 16. The bottom space 72 is open upwards so that the convective heat from the heat exchanger 50 may easily be spread into the flows of process air and dried air. The heat exchanger element 50 may be a copper pipe extending as shown in FIG. 5 or possibly extending in a more or less common heat exchanging fashion, for example a meandering fashion (not shown) through the respective bottom and rear spaces 72 and 70.

In the apparatus of FIG. 5 the minor portion 14″ of the process air 14 is initially conducted past the desiccant rotor 30 and passed through the heater 28 and rotor 30 in an enclosing casing. The resulting heated wet air flow 24 accordingly exits the dehumidifier 10 at the bottom wet air outlet 16, where it is introduced into the heat exchanger element 52.

The bottom space 72 is lined by a heat conducting material 74, such as copper.

Also according to the invention, the dehumidifier apparatus is enclosed by an internal heat insulation 60 excluding the inlet 12 and outlets 16, 22. As apparent from FIG. 2, the heat insulation 50 may include a thicker heat and sound insulation layer 64 and a thinner reflecting layer 66 inside a shell 68 in turn enclosing the insulation 60. Accordingly, the heat insulation 50 may also muffle sound from the dehumidifier apparatus.

The dehumidifier apparatus accordingly configured including heat insulation 60 and heat insulated hose 46 will not produce any appreciable amounts of internal water condensate, and will therefore not need any arrangements for handling such condensate.

The foregoing detailed description is given primarily for clearness of understanding and no unnecessary limitations are to be understood therefrom. Modifications will become obvious to those skilled in the art upon reading this disclosure and may be made without departing from the scope of the appended claims.

1. A dehumidifier apparatus comprising a sorption dehumidifier capable of dividing and converting a process air flow into a dry air flow and a heated wet air flow and having a process air inlet, a dry air outlet, a heater and a wet air outlet, characterized by
a heat exchanger arranged for heating dry air exiting the dry air outlet by wet air exiting the wet air outlet; and
a heat insulation enclosing the dehumidifier and the heat exchanger.

2. The apparatus of claim 1, wherein the heat exchanger comprises a pipe heat exchanger including a heat exchanging element dividing and uniting a wet air outlet flow in the flow path of a dry air outlet flow.

3. The apparatus of claim 2, wherein the heat exchanging element is provided with heat transfer fins.

4. The apparatus of claim 2, wherein the heat exchanging element comprises streamlined cross section tubing.

5. The apparatus of claim 2, wherein the heat exchanging element comprises dimpled surfaces.

6. The apparatus of claim 1, wherein heat insulated tubing is connected to the wet air outlet.

7. The apparatus of claim 1, wherein the heat exchanger extends in a rear space of the apparatus.

8. The apparatus of claim 7, wherein the heat exchanger also extends in a bottom space of the apparatus.

9. The apparatus of claim 7, wherein the bottom space is lined by a heat conducting material.

10. The apparatus of claim 1, wherein the heat insulation comprises a thicker heat and sound insulation layer and a thinner reflecting layer.
